(19) United States
(12) Patent Application Publication
(10) Pub. No.: US 2022/0230133 A1
(43) Pub. Date: Jul. 21, 2022

(54) SERVER DEVICE, SYSTEM, FLYING BODY, AND OPERATION METHOD OF SYSTEM

(71) Applicant: TOYOTA JIDOSHA KABUSHIKI KAISHA, Toyota-shi (JP)

(72) Inventors: Yui SUGIE, Nagoya-shi (JP); Hikaru GOTOH, Nagoya-shi (JP); Hiroki KIDO, Miyoshi-shi (JP); Shuichi SAWADA, Nagoya-shi (JP); Genshi KUNO, Kasugai-shi (JP); Katsuhiro OHARA, Nagoya-shi (JP)

(73) Assignee: TOYOTA JIDOSHA KABUSHIKI KAISHA, Toyota-shi (JP)

(21) Appl. No.: 17/553,315

(22) Filed: Dec. 16, 2021

(30) Foreign Application Priority Data
Jan. 20, 2021 (JP) 2021-007207

(51) Int. Cl. G06Q 10/08; B64C 39/02; G05D 1/00; G05D 1/02; G05D 1/10; G01C 21/34

(52) U.S. Cl. CPC G06Q 10/0833; B64C 39/024; G05D 1/0033; B64C 2201/128; G05D 1/101; G01C 21/3423; G05D 1/021

(57) ABSTRACT

A server device includes: a communication unit; and a control unit that sends and receives information to and from another device via the communication unit. Based on a captured image of a ground surface that is captured by aerial imaging, the control unit sends a flying body an instruction to airlift goods to a waiting point that is reachable from a parking point of a vehicle, and sends information on a travel route from the parking point to the waiting point to an information processing device corresponding to the vehicle.

### CROSS-REFERENCE TO RELATED APPLICATION

This application claims priority to Japanese Patent Application No. 2021-007207 filed on Jan. 20, 2021, incorporated herein by reference in its entirety.

### BACKGROUND

### 1. Technical Field

The present disclosure relates to a server device, a system, a flying body, and an operation method of the system.

### 2. Description of Related Art

When a natural disaster such as an earthquake occurs, the people affected by the disaster may live in evacuation centers for a certain period of time while receiving support from administrative agencies and the like. Various technologies have been proposed to support transport, distribution, and the like of relief goods when administrative agencies and the like provide the relief goods to evacuees. For example, a system for acquiring the needs information of evacuees to determine the distribution of relief goods is disclosed in Japanese Unexamined Patent Application Publication No. 2006-188331 (JP 2006-188331 A).

### SUMMARY

The ways of evacuation including the selection of evacuation centers are diverse. Therefore, depending on the way of evacuation, there is room to make the provision of relief goods more efficient.

The following discloses a server device and the like that make provision of relief goods more efficient.

A server device according to the present disclosure includes: a communication unit; and a control unit that sends and receives information to and from another device via the communication unit. Based on a captured image of a ground surface that is captured by aerial imaging, the control unit sends a flying body an instruction to airlift goods to a waiting point that is reachable from a parking point of a vehicle, and sends information on a travel route from the parking point to the waiting point to an information processing device corresponding to the vehicle.

An operation method according to the present disclosure is an operation method of a system including a flying body and a server device that sends and receives information to and from the flying body. Based on a captured image of a ground surface that is captured by aerial imaging, the server device sends the flying body an instruction to airlift goods to a waiting point that is reachable from a parking point of a vehicle, and sends information on a travel route from the parking point to the waiting point to an information processing device corresponding to the vehicle, and the flying body airlifts the goods in response to the instruction.

According to the present disclosure, it is possible to make the provision of relief goods more efficient.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of a goods providing system;

FIG. 2 is a diagram illustrating an operation status of the goods providing system;

FIG. 3 is a diagram showing a configuration example of a server device;

FIG. 4 is a diagram showing a configuration example of a flying body;

FIG. 5 is a diagram showing a configuration example of an information processing device; and

FIG. 6 is a sequence diagram illustrating an operation of the goods providing system.

### DETAILED DESCRIPTION OF EMBODIMENTS

Hereinafter, an embodiment will be described.

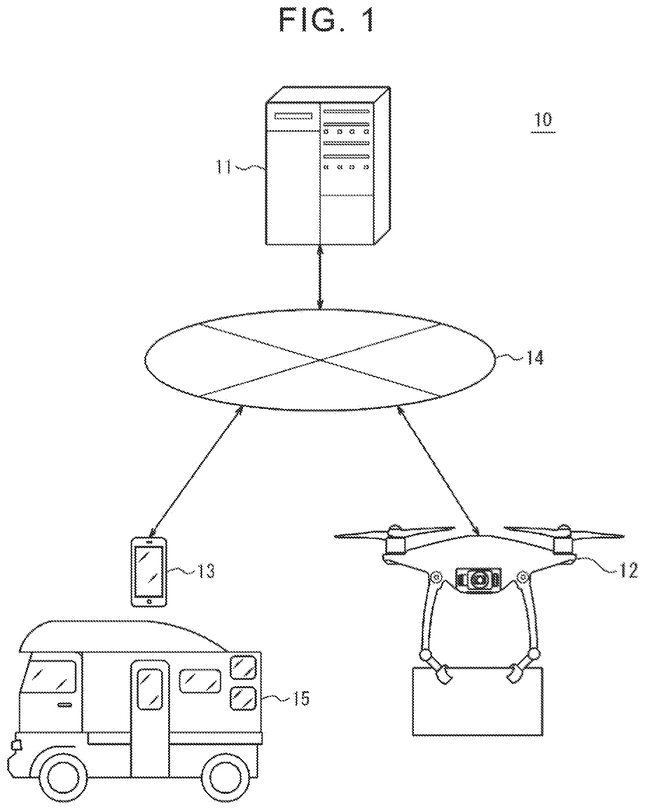

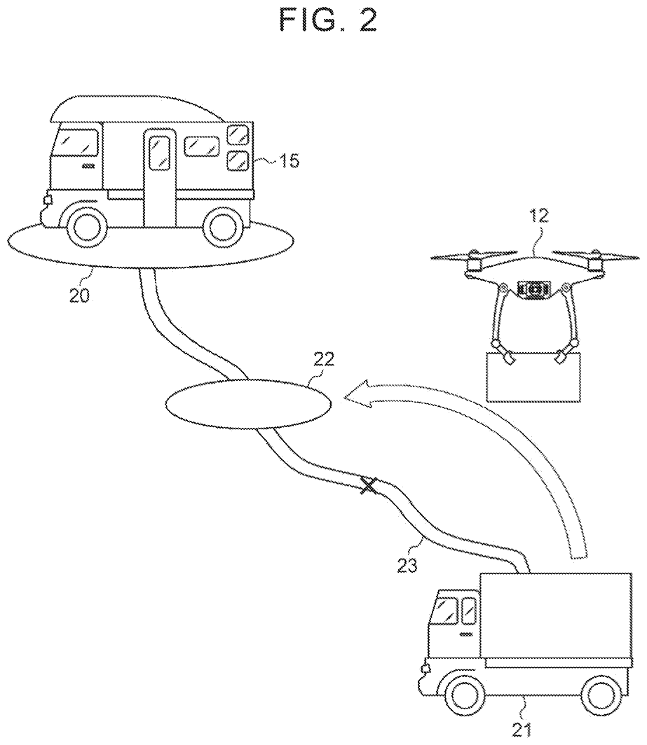

FIG. 1 is a diagram showing a configuration example of a goods providing system that supports provision of relief goods to evacuees in the present embodiment. As shown in FIG. 1, a goods providing system 10 includes a server device 11 and a flying body 12 that airlifts relief goods under the control of the server device 11. The goods providing system 10 operates in a situation as shown in FIG. 2.

FIG. 2 is a diagram illustrating a situation in which the goods providing system 10 operates. One way to evacuate in the event of a disaster is to use a car for overnight stays. For the overnight stays in the car, an evacuee moves a vehicle 15 such as a private car to any safe point 20 to park the vehicle 15. The evacuee sleeps in the vehicle 15 and spends multiple days. When relief goods to be provided to evacuees are transported by administrative agencies and the like using land transportation such as a transport truck 21, a road 23 on the way may be parted or blocked due to the disaster, or the road 23 may be too narrow to pass. In such a case, the transport truck 21 cannot reach the point where the vehicle 15 is parked (hereinafter, parking point) 20. In such a case, the flying body 12 such as a drone airlifts the relief goods transported halfway by the transport truck 21, beyond the range that the transport truck 21 can reach. This makes it possible to provide the relief goods to the evacuees. However, the parking point 20 of the vehicle 15 may be located in a crowded area of buildings, a crowded area of trees, or a mountainous area where it is difficult to secure space for takeoff and landing or approach of the flying body 12. In such a case, by causing the flying body 12 to fly to a waiting point 22 where takeoff and landing or approach is possible and guiding the evacuees to the waiting point 22, it is possible to reliably provide the relief goods to the evacuees.

As shown in FIG. 1, the server device 11 and the flying body 12 in the goods providing system 10 are connected with each other such that information communication is possible via a network 14. The server device 11 belongs to, for example, a cloud computing system or other computing systems. The server device 11 is a server that implements various functions. The flying body 12 is a drone that is powered by electric power and the like to generate lift by rotating a plurality of rotary wings, and flies in the air. The flying body 12 flies by autonomous control in the present embodiment. The flying body 12 may fly by remote control. The flying body 12 has a mechanism for flying while holding or carrying relief goods. The network 14 is, for example, the Internet. The network 14 includes an ad hoc network, a local area network (LAN), a metropolitan area network (MAN), or other networks, or any combination thereof. Further, an information processing device 13 corresponding to the vehicle 15 is connected to the network 14 such that information communication is possible. The information processing device 13 is an information processing device mounted on the vehicle 15, or an information processing device used by an evacuee who stays overnight in the vehicle 15. The information processing device 13 is, for example, a navigational device, a smartphone, a tablet terminal, a personal computer (PC), or the like.

In the goods providing system 10, the server device 11 sends the flying body 12 an instruction to airlift the relief goods to the waiting point 22 that is reachable from the parking point 20 of the vehicle 15, based on a captured image of the ground surface captured by aerial imaging. Further, based on the captured image of the ground surface captured by aerial imaging, the server device 11 sends information on a travel route from the parking point 20 to the waiting point 22 to the information processing device 13 corresponding to the vehicle 15. Then, the flying body 12 airlifts the relief goods in response to the instruction from the server device 11. With the goods providing system 10 configured as described above, when the transport truck 21 cannot reach the parking point 20 of the vehicle 15, the relief goods can be airlifted by the flying body 12. Therefore, it is possible to make the provision of the relief goods to the evacuee who stays overnight in the vehicle 15 more efficient. In addition, even when the parking point 20 of the vehicle 15 is located in a place where it is difficult to secure space for takeoff and landing or approach of the flying body 12, the flying body 12 flies to the waiting point 22 where takeoff and landing or approach is possible, and the evacuee is guided to the waiting point 22. This makes it possible to reliably provide the relief goods to the evacuee.

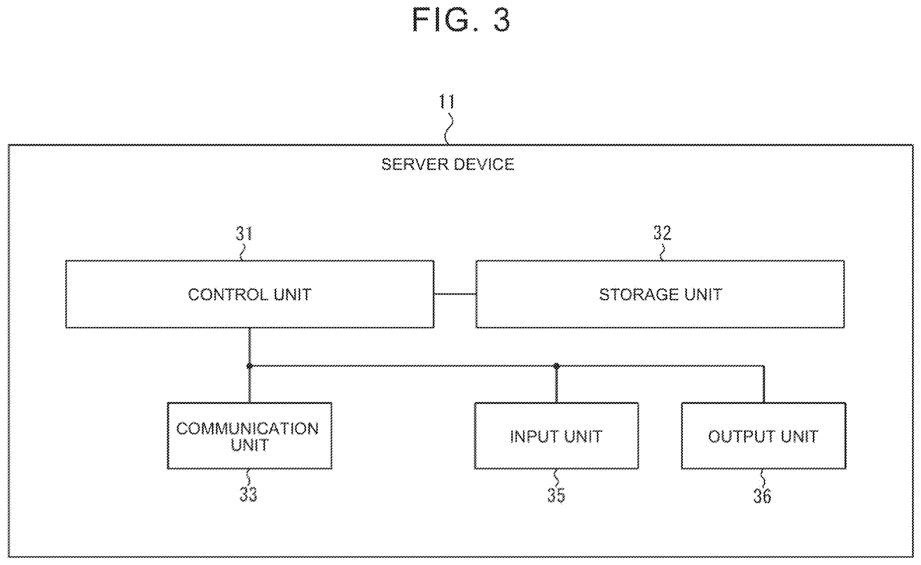

FIG. 3 shows a configuration example of the server device 11. The server device 11 includes a control unit 31, a storage unit 32, a communication unit 33, an input unit 35, and an output unit 36. The server device 11 belongs to, for example, a cloud computing system or other computing systems. The server device 11 is, for example, a server computer that functions as a server that implements various functions. The server device 11 may be one or more server computers that are connected to each other such that information communication is possible and operate in cooperation with each other.

The control unit 31 includes one or more processors, one or more dedicated circuits, or a combination thereof. The processor is a general-purpose processor such as a central processing unit (CPU) or a dedicated processor specialized for a specific process such as a graphics processing unit (GPU). The dedicated circuit is, for example, a field-programmable gate array (FPGA) or an application-specific integrated circuit (ASIC). The control unit 31 executes information processing related to the operation of the server device 11 while controlling each unit of the server device 11.

The storage unit 32 includes, for example, one or more semiconductor memories, one or more magnetic memories, one or more optical memories, or a combination of at least two of them that function as a main storage device, an auxiliary storage device, or a cache memory. The semiconductor memory is, for example, a random access memory (RAM) or a read-only memory (ROM). The RAM is, for example, a static RAM (SRAM) or a dynamic RAM (DRAM). The ROM is, for example, an electrically erasable programmable read-only memory (EEPROM). The storage unit 32 stores information used for the operation of the server device 11 and the information obtained through the operation of the server device 11.

The communication unit 33 includes one or more communication interfaces. The communication interface is, for example, a LAN interface. The communication unit 33 receives the information used for the operation of the server device 11. The communication unit 33 transmits the information obtained through the operation of the server device 11. The server device 11 is connected to the network 14 through the communication unit 33. The server device 11 performs information communication with other devices via the network 14.

The input unit 35 includes one or more input interfaces. The input interface is, for example, a physical key, a capacitive key, a pointing device, a touch screen integrated with a display, or a microphone that receives voice input. The input interface may further include a camera that takes in captured images or image codes, or an integrated circuit (IC) card reader. The input unit 35 receives operation for inputting the information used for the operation of the server device 11, and transmits the input information to the control unit 31.

The output unit 36 includes one or more output interfaces. The output interface is, for example, a display or a speaker. The display is, for example, a liquid crystal display (LCD) or an organic electro-luminescence (OEL) display. The output unit 36 outputs the information obtained through the operation of the server device 11.

The function of the server device 11 is realized by executing a control program using the processor included in the control unit 31. The control program is a program for causing a computer to execute a process of a step included in the operation of the server device 11 such that the computer can realize a function corresponding to the process of the step. That is, the control program is a program for causing the computer to function as the server device 11.

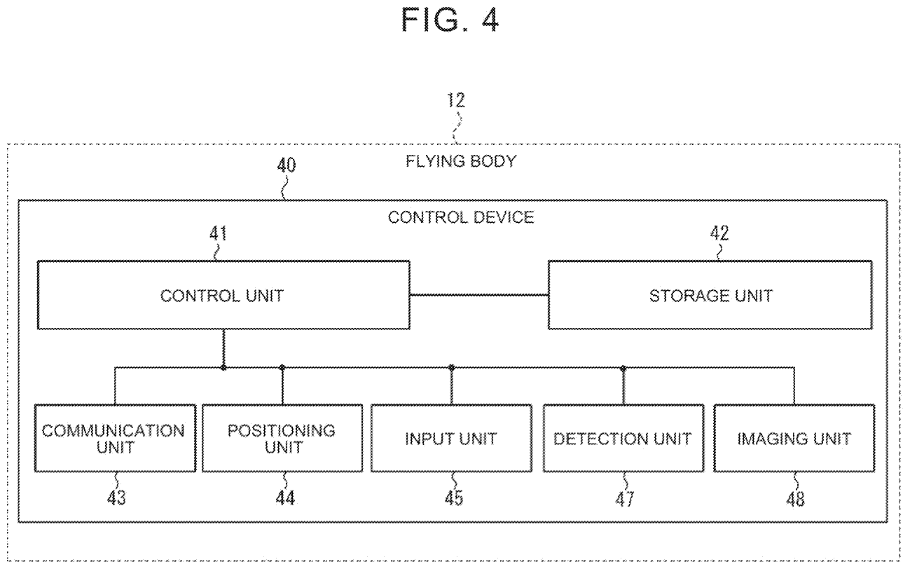

FIG. 4 shows a configuration example of a control device 40 mounted on the flying body 12. When the flying body 12 flies from the transport truck 21 while carrying and holding the relief goods, the control device 40 comprehensively controls the operation of the flying body 12 while performing information communication with the server device 11. The control device 40 includes a control unit 41, a storage unit 42, a communication unit 43, a positioning unit 44, an input unit 45, an output unit 46, a detection unit 47, and an imaging unit 48.

The control unit 41 includes one or more processors, one or more dedicated circuits, or a combination thereof. The processor is a general-purpose processor such as a CPU, or a dedicated processor specialized for a specific process. The dedicated circuit is, for example, an FPGA or an ASIC. The control unit 41 executes information processing related to the operation of the control device 40 while controlling each unit of the control device 40.

The storage unit 42 includes, for example, one or more semiconductor memories, one or more magnetic memories, one or more optical memories, or a combination of at least two of them that function as a main storage device, an auxiliary storage device, or a cache memory. The semiconductor memory is, for example, a RAM or a ROM. The RAM is, for example, an SRAM or a DRAM. The ROM is, for example, an EEPROM. The storage unit 42 executes information processing related to the operation of the control device 40, and stores information used for the operation of the control device 40 and information obtained through the operation of the control device 40.

The communication unit 43 includes one or more communication interfaces. The communication interface is, for example, an interface compatible with mobile communication standards such as Long Term Evolution (LTE), 4th Generation (4G) or 5th Generation (5G). The communication unit 43 receives the information used for the operation of the control device 40. The communication unit 43 transmits the information obtained through the operation of the control device 40. The control device 40 is connected to the network 14 via the base station of the mobile communication through the communication unit 43. The control device 40 performs information communication with other devices via the network 14.

The positioning unit 44 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. The positioning unit 44 acquires position information of the flying body 12.

The input unit 45 includes one or more input interfaces. The input interface is, for example, a camera that takes in captured images, a physical key, a capacitive key, a pointing device, a touch screen integrated with a display, or a microphone that receives voice input. The input interface may further or include an IC card reader. The input unit 45 receives operation for inputting the information used for the operation of the control device 40, and transmits the input information to the control unit 41.

The output unit 46 includes one or more output interfaces. The output interface is, for example, a display or a speaker. The display is, for example, an LCD or an organic EL display. The output unit 46 outputs the information obtained through the operation of the control device 40.

The detection unit 47 includes sensors that detect a motion state of the flying body 12 and a situation around the flying body 12. The motion state of the flying body 12 is the flight speed, the altitude, the inclination of attitude, and the like. The sensors that detect these include a speed sensor, an altitude sensor, an angular velocity sensor, and the like. The situation around the flying body 12 represents presence or absence of other objects such as obstacles, the distance with respect to other objects, and the like. The sensors that detect these include an image sensor, a distance sensor, and the like. The detection unit 47 sends the detection results of the sensors to the control unit 41.

The imaging unit 48 includes one or more cameras provided at positions that allow capturing of images around and below the flying body 12 and a control circuit thereof. Each camera of the imaging unit 48 may be a monocular camera or a stereo camera. The imaging unit 48 captures an image of the ground surface or space around the flying body 12 at any timing and sends the captured image to the control unit 41, while the flying body 12 is flying.

The function of the control device 40 is realized by executing a control program using the processor included in the control unit 41. The control program is a program for causing a computer to execute a process of a step included in the operation of the control device 40 such that the computer can realize a function corresponding to the process of the step. That is, the control program is a program for causing the computer to function as the control device 40. A part or all of the functions of the control device 40 may be realized by a dedicated circuit included in the control unit 41.

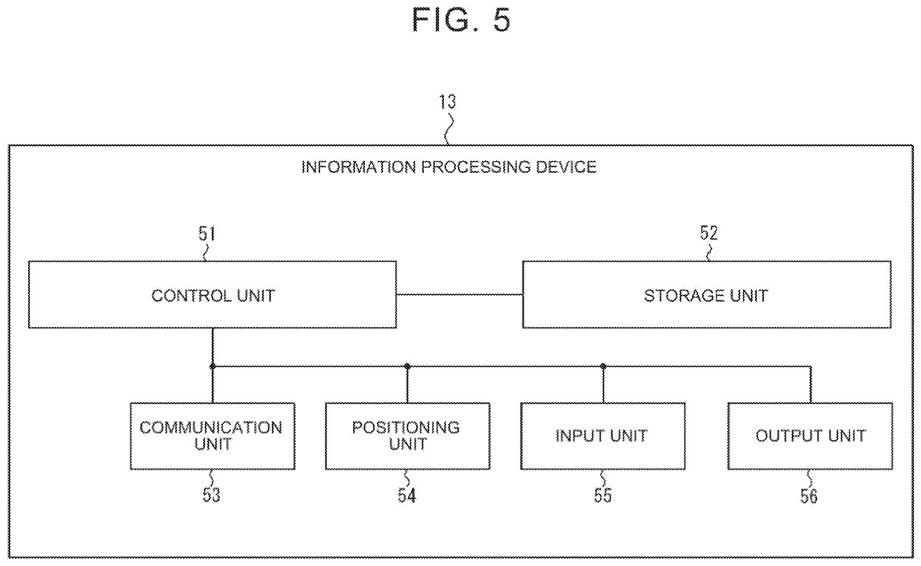

FIG. 5 shows a configuration example of the information processing device 13. The information processing device 13 includes a control unit 51, a storage unit 52, a communication unit 53, a positioning unit 54, an input unit 55, and an output unit 56. The information processing device 13 is an information processing device corresponding to the vehicle 15. The information processing device 13 is used by the evacuee, for example, or is mounted on the vehicle 15. The information processing device 13 is, for example, a PC, a tablet terminal, a mobile phone, a navigation device or the like.

The control unit 51 includes one or more processors, one or more dedicated circuits, or a combination thereof. The processor is a general-purpose processor such as a CPU, or a dedicated processor specialized for a specific process. The dedicated circuit is, for example, an FPGA or an ASIC. The control unit 51 can perform information processing related to the operation of the information processing device 13 while controlling each unit of the information processing device 13.

The storage unit 52 includes one or more semiconductor memories, one or more magnetic memories, one or more optical memories, or a combination of at least two of them. The semiconductor memory is, for example, a RAM or a ROM. The RAM is, for example, an SRAM or a DRAM. The ROM is, for example, an EEPROM. The storage unit 52 functions as, for example, a main storage device, an auxiliary storage device, or a cache memory. The storage unit 52 stores information used for the operation of the information processing device 13 and information obtained through the operation of the information processing device 13.

The communication unit 53 includes one or more communication interfaces. The communication interface is, for example, an interface compatible with mobile communication standards such as LTE, 4G, or 5G, or a LAN interface. The communication unit 53 receives the information used for the operation of the information processing device 13. The communication unit 53 transmits the information obtained through the operation of the information processing device 13. The information processing device 13 is connected to the network 14 via a nearby router device or a base station of mobile communication through the communication unit 53. The information processing device 13 performs information communication with other devices via the network 14.

The positioning unit 54 includes one or more GNSS receivers. The GNSS includes, for example, at least one of GPS, QZSS, BeiDou, GLONASS, and Galileo. The positioning unit 54 acquires position information of the information processing device 13.

The input unit 55 includes one or more input interfaces. The input interface is, for example, a physical key, a capacitive key, a pointing device, a touch screen integrated with a display, or a microphone that receives voice input. The input interface may further include a camera that takes in captured images or image codes, or an IC card reader. The input unit 55 receives operation for inputting the information used for the operation of the information processing device 13, and transmits the input information to the control unit 51.

The output unit 56 includes one or more output interfaces. The output interface is, for example, an external or built-in display that outputs information as an image or video, a speaker that outputs information as audio, or a connection interface for an external output device. The display is, for example, an LCD or an organic EL display. The output unit 56 outputs the information obtained through the operation of the information processing device 13. The output unit 56 corresponds to the “display unit”.

The operation of the information processing device 13 is realized by executing a program using the processor included in the control unit 51. Alternatively, a part or all of the operation of the information processing device 13 may be executed by a dedicated circuit included in the control unit 51.

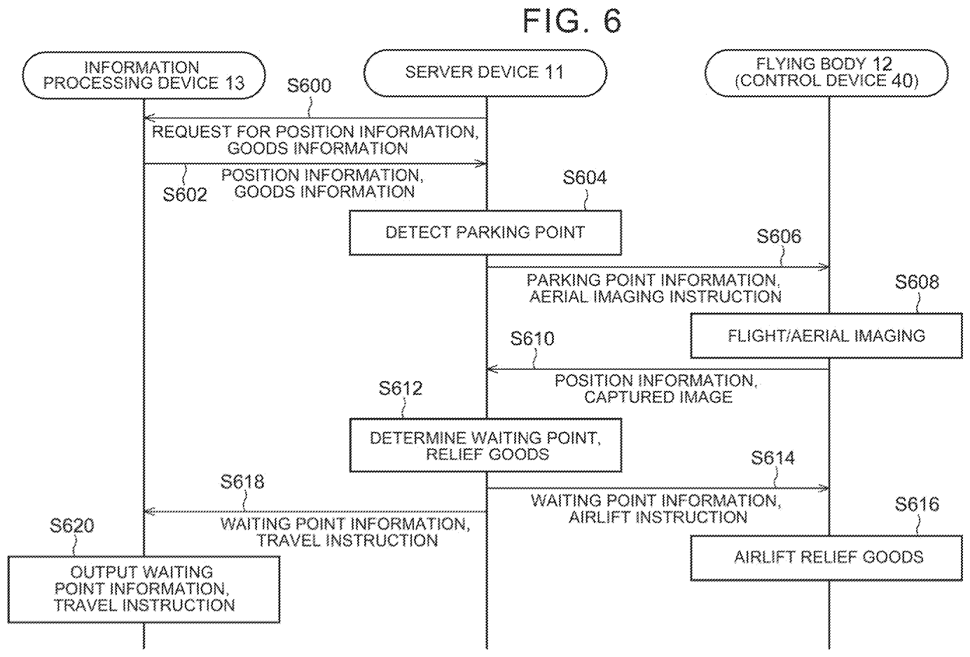

FIG. 6 is a sequence diagram showing an operation procedure of the goods providing system 10. FIG. 6 shows the procedure of cooperative operation by the server device 11, the flying body 12, and the information processing device 13. The procedure of FIG. 6 is performed, for example, when the administrative agencies and the like are dispatched to provide the relief goods after the evacuee has started overnight stays in the vehicle 15.

In step S600, the server device 11 requests position information and goods information from the information processing device 13. In the server device 11, the control unit 31 sends a request for the position information and the goods information to the information processing device 13 via the communication unit 33. The goods information is information for specifying the relief goods required by the evacuees. The goods information includes the types and the quantities of relief goods and the attributes of the evacuees. The types of the relief goods represent types of food, types of daily necessities, and the like. The attributes of the evacuees include, for example, the gender, age, number, health condition, and the like of the evacuees. In the information processing device 13, the control unit 51 receives the request for the position information and the goods information through the communication unit 53.

In step S602, the information processing device 13 sends the position information and the goods information to the server device 11. In the information processing device 13, the control unit 51 acquires the position information of the current position from the positioning unit 54. The control unit 51 acquires the goods information input by the evacuee from the input unit 55. For example, the control unit 51 displays the options of the types of goods and the attributes of the evacuee on the output unit 56. The control unit 51 receives an input of selection of the options by the evacuee through the input unit 55. Then, the control unit 51 sends the position information and the goods information from the communication unit 53 to the server device 11. In the server device 11, the control unit 31 receives the position information and the goods information through the communication unit 33.

In step S604, the server device 11 detects the parking point 20. In the server device 11, the control unit 31 detects the parking point 20 of the vehicle 15, based on the position information received from the information processing device 13 and map information stored in advance in the storage unit 32. The information processing device 13 is used by the evacuee who stays overnight in the vehicle 15, or is mounted on the vehicle 15. Therefore, the position of the information processing device 13 corresponds to the parking point 20.

In step S606, the server device 11 sends parking point information and an aerial imaging instruction to the flying body 12. The control unit 31 of the server device 11 sends, to the flying body 12, the parking point information indicating the parking point 20 and the aerial imaging instruction to capture an image of a range including the parking point on the ground surface from the sky, via the communication unit 33. The flying body 12 is loaded on the transport truck 21 that is dispatched by administrative agencies and the like for transporting the relief goods, for example. In the flying body 12, the control unit 41 of the control device 40 receives the parking point information and the aerial imaging instruction, via the communication unit 43.

In step S608, the flying body 12 flies to perform aerial imaging. The control unit 41 of the control device 40 controls each unit of the flying body 12 such that the flying body 12 flies along the flight route including the vicinity of the parking point. The control unit 41 performs aerial imaging using the imaging unit 48 during the flight. The control unit 41 associates the captured image with the position information at the time of aerial imaging that is obtained from the positioning unit 44, and stores the captured image of each point in the storage unit 42. Thus, the control unit 41 stores the captured images of the area including the parking point 20 and at least a part of the flight route, in the storage unit 42.

In step S610, the flying body 12 sends the position information and the captured image to the server device 11. The control unit 41 of the control device 40 sends, to the server device 11, the captured image stored in the storage unit 42 and the position information of the point of capturing the image by aerial imaging, via the communication unit 43. In the server device 11, the control unit 31 receives the position information and the captured image via the communication unit 33.

In step S612, the server device 11 determines the waiting point 22 and the relief goods. The waiting point 22 is located within a range of an appropriate distance from the parking point 20 (for example, range of a radius of several kilometers). The waiting point 22 is, for example, vacant land of several meters square or more, parking lots, parks, schoolyards, premises of facilities, rooftops of facilities, and the like that are not covered by other buildings, trees, and the like and that have a space where the flying body 12 can take off and land or approach. Furthermore, the waiting point 22 is a point that is connected to the parking point 20 through the travel route along which traveling is possible. The travel route is a road having such a width that a vehicle such as a passenger car can travel or a small road that allows travel by walking. When a plurality of routes is conceivable, the travel route is a route with the shortest travel distance or the shortest required time. The control unit 31 of the server device 11 performs image recognition processing on the captured image and detects a point satisfying the above-described conditions. Further, the control unit 31 collates the goods information received from the information processing device 13 with list information of the relief goods that can be provided by the transport truck 21 that is stored in advance in the storage unit 32, and determines the relief goods to be provided to the evacuees using the information processing device 13.

When detecting a plurality of points satisfying the above conditions, the control unit 31 determines one waiting point 22 from the plurality of points by a further condition. For example, the control unit 31 determines a point with the shortest linear distance or the shortest travel distance from the parking point 20 as the waiting point 22. Further, the control unit 31 may determine such a point that the flight distance for the flying body 12 from the transport truck 21 is the shortest as the waiting point 22. Alternatively, the control unit 31 may sum the linear distance or the travel distance from the parking point 20 and the flight distance for the flying body 12 with weights assigned thereto as appropriate, to determine such a point that the sum is the smallest as the waiting point 22. Alternatively, the control unit 31 may determine the waiting point depending on the volume or weight of the relief goods. For example, when the volume or weight of the relief goods is equal to or more than any reference value, the control unit 31 may set, as an option, a point that is connected to the parking point 20 through the travel route along which the vehicle can travel. Further, when the volume or weight of the relief goods is less than the reference value, the control unit 31 may include, in the options, a point that is connected to the parking point 20 through the travel route along which travel by walking is possible, to determine the waiting point 22.

In step S614, the server device 11 sends the waiting point information and an airlift instruction to the flying body 12. The control unit 31 of the server device 11 sends, to the flying body 12, the waiting point information indicating the waiting point 22 and the airlift instruction for airlifting the determined relief goods to the waiting point 22, via the communication unit 33. The information such as the types and the quantities of the relief goods to be airlifted is added to the airlift instruction. In the flying body 12, the control unit 41 of the control device 40 receives the parking point information and the aerial imaging instruction via the communication unit 43. At this time, the flying body 12 may return to the transport truck 21 for waiting after the aerial imaging, or may be on the way to return to the transport truck 21.

In step S616, the flying body 12 performs the airlifting of the relief goods. The flying body 12 loads or holds the relief goods on the transport truck 21 while waiting on the transport truck 21 or after returning to the transport truck 21. In the transport truck 21, a worker may acquire the information on the relief goods from the control device 40 of the flying body 12 to manually cause the flying body 12 to carry or hold the designated relief goods. Alternatively, an automated device may acquire the information on the relief goods from the flying body 12 to automatically cause the flying body 12 to carry or hold the designated relief goods. In the flying body 12, the control unit 41 of the control device 40 derives a flight route to the waiting point 22 based on the map information stored in advance in the storage unit 42, for example. The control unit 41 controls each unit of the flying body 12 such that the flying body 12 flies along the derived flight route. Thus, the flying body 12 flies to the waiting point 22 while carrying or holding the relief goods, and lands or descends at the waiting point 22 to unload the relief goods.

On the other hand, in step S618, the server device 11 sends the waiting point information and a travel instruction to the information processing device 13. The control unit 31 of the server device 11 sends, to the information processing device 13, the waiting point information indicating the waiting point 22 and the travel instruction prompting the travel to the waiting point 22, via the communication unit 33, The travel instruction includes information indicating a travel route by a vehicle or walking. Information such as the types and the quantities of the relief goods to be airlifted may be added to the travel instruction. Furthermore, an expected arrival time of the flying body 12 may be added to the travel instruction. The expected arrival time is obtained by the control unit 31 based on the distance to the waiting point 22 and the standard flight speed of the flying body 12. In the information processing device 13, the control unit 51 receives the waiting point information and the travel instruction via the communication unit 53.

In step S620, the information processing device 13 outputs the waiting point information and the travel instruction. In the information processing device 13, the control unit 51 outputs from the output unit 56 by display or the like the information indicating the waiting point 22 and the information indicating the travel route by the vehicle or walking. The waiting point 22 and the travel route are shown by superimposition on a map, for example, and whether the travel route is intended for travel by the vehicle or walking is shown. Further, the control unit 51 may display information such as the expected arrival time of the flying body 12, the types, the quantities, and the like of the relief goods to be airlifted. The above output allows the evacuees to recognize the waiting point 22 and travel toward the waiting point 22.

Through the operation of the goods providing system 10 as described above, the evacuees can travel to the waiting point 22 by the vehicle 15 or walking and receive the provision of the relief goods that the flying body 12 airlifts, which makes the provision of the relief goods more efficient.

When multiple groups of evacuees are respectively stay overnight in the vehicles 15, the goods providing system 10 may execute the procedure of FIG. 6 for each information processing device 13 of each vehicle 15 to set the waiting point 22 for each information processing device 13 or set a common waiting point 22 for the information processing devices 13. For example, the information processing device 13 and the server device 11 execute steps S600 to S604 for each information processing device 13, and the server device 11 detects the parking point 20 for each information processing device 13. In step S612, the server device 11 determines the common waiting point 22 that is reachable from a plurality of parking points 20. For example, the server device 11 determines the waiting point 22 such that the distances from the parking points 20 to the waiting point 22 are equal or the difference in distance is the smallest. By doing so, it is possible to achieve fairness among the evacuees.

Alternatively, the server device 11 may adjust the length of the travel route for each parking point 20 depending on various conditions, to determine the common waiting point 22 for the plurality of parking points 20. For example, when determining the waiting point 22 by adopting a travel route by the vehicle, the server device 11 acquires information on the remaining amount of fuel of the vehicle 15 from each information processing device 13. The server device 11 determines the common waiting point 22 such that the parking point 20 for the vehicle 15 with a smaller remaining amount has a shorter travel route to the waiting point 22. In addition, when determining the waiting point 22 by adopting a travel route by walking, the server device 11 determines the common waiting point 22 such that the parking point 20 with a greater quantity of goods to be provided has a shorter travel route to the waiting point 22. Alternatively, when the attribute information of the evacuee indicates that the burden of the travel by walking is large, for example, when the evacuee is injured or aged, the server device 11 determines the common waiting point 22 such that the evacuee with a larger burden has a shorter travel route to the waiting point 22. This makes it possible to more finely contribute to the fairness among the evacuees.

According to a modification, in step S618, the server device 11 sends, to the information processing device 13, the captured image captured by the flying body 12 by aerial imaging, together with the waiting point information and the travel instruction. The server device 11 may add, to the captured image, the information on the environment around the parking point 20 that can be acquired from the captured image and send them to the information processing device 13. The information on the environment around the parking point 20 includes, for example, information on whether passage through the road is possible. When the information processing device 13 outputs the captured image, or the captured image and the information added thereto, the evacuees can easily know the surrounding situation at the time of traveling from the parking point 20 to another point.

In the above-described embodiment, a processing/control program that defines the operation of the information processing device 13 and the control device 40 may be stored in the server device 11 and downloaded to each device via the network 14. The processing/control program is stored in a non-transitory recording/storage medium readable by each device, and each device may read from the medium.

The present disclosure is not limited to the embodiment described above. For example, a plurality of blocks shown in the block diagram may be integrated with each other. Alternatively, the blocks may be obtained by dividing one block. Instead of executing the steps in the flowchart in a chronological sequence in concert with description, the steps may be executed in parallel or in a different sequence, depending on processing ability of a device that executes the steps, or as necessary. Other changes may be made without departing from the scope of the present disclosure.

What is claimed is:

1. A server device comprising:
a communication unit; and
a control unit that sends and receives information to and from another device via the communication unit,
wherein based on a captured image of a ground surface that is captured by aerial imaging, the control unit sends a flying body an instruction to airlift goods to a waiting point that is reachable from a parking point of a vehicle, and sends information on a travel route from the parking point to the waiting point to an information processing device corresponding to the vehicle.

2. The server device according to claim 1, wherein the travel route is a travel route by the vehicle or walking.

3. The server device according to claim 2, wherein the control unit selects the travel route by the vehicle or walking in accordance with a quantity of the goods.

4. The server device according to claim 1, wherein the control unit determines the waiting point such that distances from a plurality of the parking points are equal.

5. The server device according to claim 1, wherein the control unit determines a point different from the parking point as the waiting point.

6. The server device according to claim 1, wherein the control unit determines a point outside a reachable range for a vehicle that transports the goods as the waiting point.

7. The server device according to claim 1, wherein the control unit sends the information processing device information on an environment around the parking point based on the captured image.

8. The server device according to claim 1, wherein the control unit selects the goods based on a request for the goods that is received from the information processing device.

9. The server device according to claim 1, wherein the control unit receives the captured image from the flying body.

10. A system comprising the flying body and the server device according to claim 1.

11. A flying body that flies based on an instruction received from the server device according to claim 1.

12. An operation method of a system including a flying body and a server device that sends and receives information to and from the flying body, wherein:
based on a captured image of a ground surface that is captured by aerial imaging, the server device sends the flying body an instruction to airlift goods to a waiting point that is reachable from a parking point of a vehicle, and sends information on a travel route from the parking point to the waiting point to an information processing device corresponding to the vehicle; and
the flying body airlifts the goods in response to the instruction.

13. The operation method according to claim 12, wherein the travel route is a travel route by the vehicle or walking.

14. The operation method according to claim 13, wherein the server device selects the travel route by the vehicle or walking in accordance with a quantity of the goods.

15. The operation method according to claim 12, wherein the server device determines the waiting point such that distances from a plurality of the parking points are equal.

16. The operation method according to claim 12, wherein the server device determines a point different from the parking point as the waiting point.

17. The operation method according to claim 12, wherein the server device determines a point outside a reachable range for a vehicle that transports the goods as the waiting point.

18. The operation method according to claim 12, wherein the server device sends the information processing device information on an environment around the parking point based on the captured image.

19. The operation method according to claim 12, wherein the server device selects the goods based on a request for the goods that is received from the information processing device.

20. The operation method according to claim 12, wherein:
the flying body generates the captured image by aerial imaging and sends the captured image to the server device; and
the server device receives the captured image.
